(19) United States
(12) Patent Application Publication
(10) Pub. No.: US 2014/0032410 A1
(43) Pub. Date: Jan. 30, 2014

(54) METHOD AND SYSTEM FOR LINKING AND CONTROLING OF PAYMENT CARDS WITH A MOBILE

(71) Applicant: IPAY INTERNATIONAL, S.A., Luxembourg (LU)

(72) Inventors: Christo GEORGIEV, Zurich (CH); Yavor Petrov, Varna (GB)

(73) Assignee: iPAY INTERNATIONAL, S.A., Luxembourg (LU)

(21) Appl. No.: 13/729,269

(22) Filed: Dec. 28, 2012

Related U.S. Application Data
(60) Provisional application No. 61/674,935, filed on Jul. 24, 2012.

(51) Int. Cl. G06Q 20/40

(52) U.S. Cl. CPC G06Q 20/405
USPC 705/44

(57) ABSTRACT

A unique payment card control system that controls payment for a transaction for goods or services, the control being implemented via a mobile communication device. In one embodiment, all transactions with user's payment card are blocked, wherein control system does not allow any transaction requests received. Prior to conducting a transaction, the user sends a control command via the mobile communication device to the control system in order to unblock (enable) the associated card. The control system then determines that the card is not blocked and allows the transaction. From its mobile device the user is able to send a command to customize both the number of consecutive transactions and duration before the card is blocked again automatically. Alternatively, rules are provided that restrict transactions based on the payment card designated for the transaction, the vendor, the type of goods or services being exchanged for payment etc.

### RELATED APPLICATIONS

This application claims priority to U.S. Provisional Patent Application Ser. No. 61/674,935 filed Jul. 24, 2012 and incorporated herein by reference in its entirety.

### BACKGROUND OF THE INVENTION

a. Field of Invention

This application pertains to a method and system in which customers control access to one or more payment cards, including debit, credit and other similar payment cards that normally are used to provide automated payment for goods, services, etc.

b. Description of the Prior Art

Currently people use a variety of payment cards (debit cards, credit cards, prepaid cards, virtual cards via smartphones, etc.) to pay for goods and services at brick-and-mortar locations or on-line via the Internet. In general, payment cards are the preferred method of payment for consumers who want maximum convenience. In fact, some merchants, especially on line, accept only payment cards as payment means,

However, because of the way card payments are currently structured, an increasing number of people become victims of fraud. Fraudulent transactions can occur even if a consumer is very careful with his payment cards and can have a huge impact on a consumer's finances, credit rating and on his or her psyche.

Studies have shown that the police and other local or national authorities do little to trace down and prosecute the perpetrators, and accordingly, the costs of the stolen goods or services must be born by somebody, be it the merchant, the bank, an insurance company, or some other intermediary entity.

Moreover, fraudulent transaction have a secondary tangible and intangible impact on all the parties involved. The consumers have to get new payment cards, deal with credit rating problems and damage to their reputation, etc. Merchants and banks must bear the fixed incremental cost of each transaction, including the fraudulent ones, handle inconvenienced customers, the increased cost of insurance, etc. and the intangible cost associated with the loss of reputation of the merchant. While the cost can ultimately be passed on to the consumer, the development of this environment hurts business as a whole.

To tackle the different types of fraud the banking industry put in place a number of initiatives. Intelligent computer systems allegedly provided with real-time fraud monitoring are used by banks and card companies to monitor payment card accounts for “unusual” spending patterns. Sophisticated fraud screening detection tools are in use by retailers and merchants. IC Chips and personal identification numbers (PIN) have been introduced as a requirement for using a payment card to conduct a transaction at a point-of-sale terminal (POS) in many countries.

Despite all these efforts, during the last years there has been a global geometric increase in fraudulent activities.

There is thus a need to provide additional tools to control payment cards, especially by the customers. This application describes a system and method that can be implemented and used by consumers to minimize or eliminate fraudulent transactions via payment cards.

### SUMMARY OF THE INVENTION

Embodiments of the present invention address the above needs by providing an apparatus (e.g., a system, computer program product, and/or other device) and method allowing a user to gain full control on its payment card in real time via its mobile phone, smartphone, tablet or PDA device.

Briefly, this invention pertains to a method and system for linking and control of a payment card or account with a mobile device. The user has a mobile device like smart phone, tablet, PDA, a laptop computer, etc., that is used to control one or more payment cards linked to the mobile device. It should be understood that the invention may also be implemented using other devices, such as a desk top computer. The user first gains a full control over his payment card by sending commands from his mobile device and the associated control system.

In one embodiment of the present invention the user can choose to send a command to block its card so no transactions with the card can be permitted. When the user intends to make a transaction with the card he sends a command via its mobile device to unblock the card. After the transaction is completed the user can send a command to block the card again so no further transactions with the card can be made. Because the control system works with user mobile device and commands are processed in real time the user can conveniently unblock/block its payment card just before/after the transaction is completed.

In another embodiment of the present invention the user can choose to send a command to block its card for being used on ATM. When the user intends to withdraw money with its card he sends a command via its mobile device to unblock the card for ATM transactions only. After the withdrawal is completed the user can send a command to block the card for ATM transactions again. In this case the system performs additional verification by checking at least one transaction characteristic to determine either to permit or rejects the transaction with the payment card.

### BRIEF DESCRIPTION OF THE DRAWINGS

FIG. 1 shows a block diagram of a system constructed in accordance with this invention;

FIG. 2 shows a flow chart illustrating a user signing up for the system;

FIG. 3 shows a flow chart illustrating partially how a transaction is performed on the system; and

FIG. 4 shows a continuation for the flow chart of FIG. 3;

FIG. 5 shows the organization of the data in the database; and

FIG. 6 shows a screen shot of a smartphone display for the present system.

### DETAILED DESCRIPTION

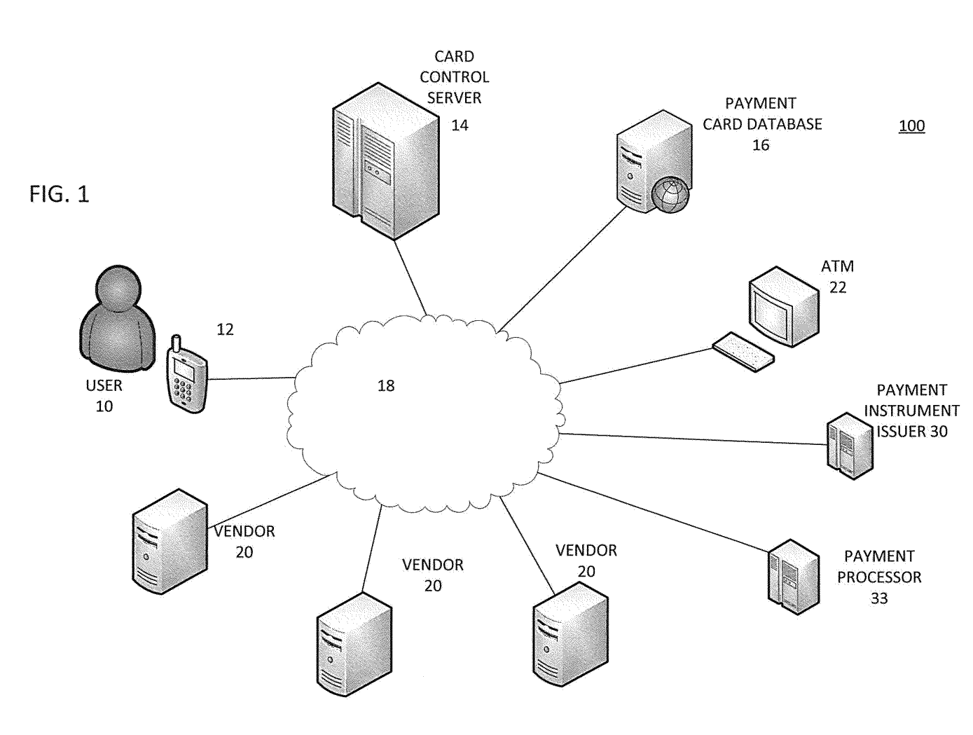

Referring first to FIG. 1, a system 100 constructed in accordance with the present invention includes a mobile device 12 associated with a user 10, a card control server 14, a payment card database 16 and various entities such as vendors 20, or other entities that can be used to obtain cash, goods or services, such as an ATM device 22 and various issuers of payment instruments 30 or other intermediary entities, such as payments processors 33. These elements can be disposed adjacent to each other or can be remote and communication between them is implemented over a standard communication network, such as the Internet 18.

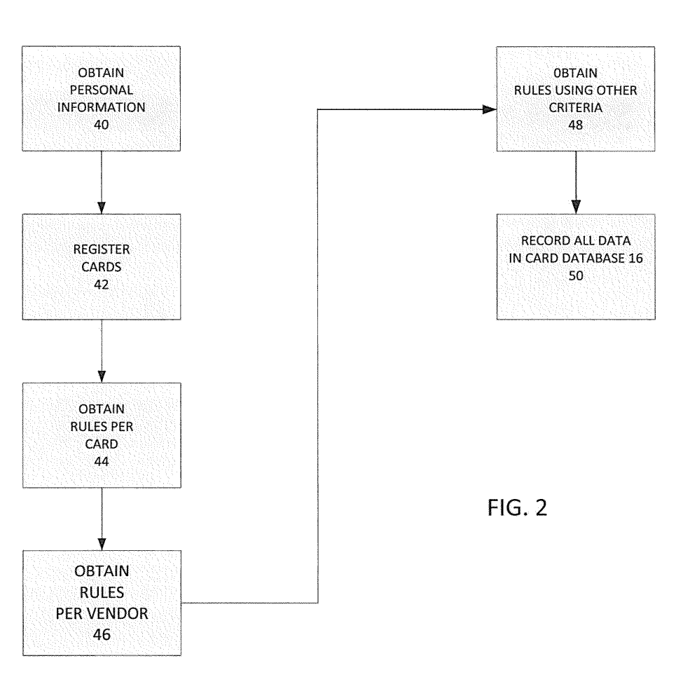

Before the system is used, the user 10 registers with the system as illustrated in the flow chart of FIG. 2. In step 40, the user provides personal information, such as name, address, cell phone number, email address, etc.

In step 42, the user provides information identifying all the payment cards that will be monitored/controlled by the system. The system can control only payment cards for which the respective payment card issuer 30 or processor 33 is already connected to the system. As previously indicated, such payment cards may include debit cards, credit cards, virtual accounts using apps on smart phones, cash cards, and any other instruments usually issued by banks and other institutions that can be used to buy goods, services, or even to make donations. The payment cards can be used in either brick-and-mortar stores or on virtual vendor websites. Moreover, as previously indicated, one or more such cards may be used to withdraw cash from an account using an ATM device. Each of these cards may be identified by, or associated with a respective a card number, an account number, , a security code, an/or other more sophisticated security indicia such as biometric identification means such as thumb prints, etc.

During (or after registration) the user may also specify (step 44) some rules for some or all the cards that put some restrictions on how, where and when all or each of the cards may be used. For example, the user may specify that normally a specific card may be used unless otherwise restricted. Alternatively, a specific card may be restricted so that it cannot be used unless a specific permission is received.

Another type of restriction may be related to the kinds of goods or services that can be or, alternatively, cannot be provided with the card. For example, a card may be restricted to groceries. Another card may be restricted so that it can be used only to get money. A card may be restricted so that it cannot be used to buy alcoholic beverages. In one embodiment, a card may be used a predetermined number of times for any transactions, or to spend only a predetermined amount for a given time period (e.g., a day, a week, a months, etc.)

In addition, or alternatively to the rules provided in step 44, another set of rules may be provided in step 46. While the rules of step 44 are card-specific, meaning that a particular card may or may not be used to obtain some goods or services, in step 46 rules are provided that are vendor-specific. For example a user may restrict transactions to only particular groceries, bookstores, etc. Alternatively, the user may specify that no transactions may take place in bars.

In addition, other types of restrictions may be defined by other rules defined in step 48, For example, one rule may specify that all transactions can occur only in a specific geographic area. Another rule may specify that all transactions may occur only on specific dates, specific days of the week, etc. Other rules may have similar limitations but they may be restrictive rather than permissive.

While the rules have been described as being card-specific, vendor-specific, or using other criteria, combination rules may also be specified by the user. For example, one card may be used only to buy certain items in a specific store and/or specific geographic area, etc.

All these rules may be established by the user at the time of registration, or may be added or amended at a later time. In the flow chart, the rules are defined in three separate stages, however they may be defined in a single stage as welt

The information collected during the registration time (or at a later time) is preferably confirmed with the user 10 to insure that it is accurate and then stored in the database 16 in step 50.

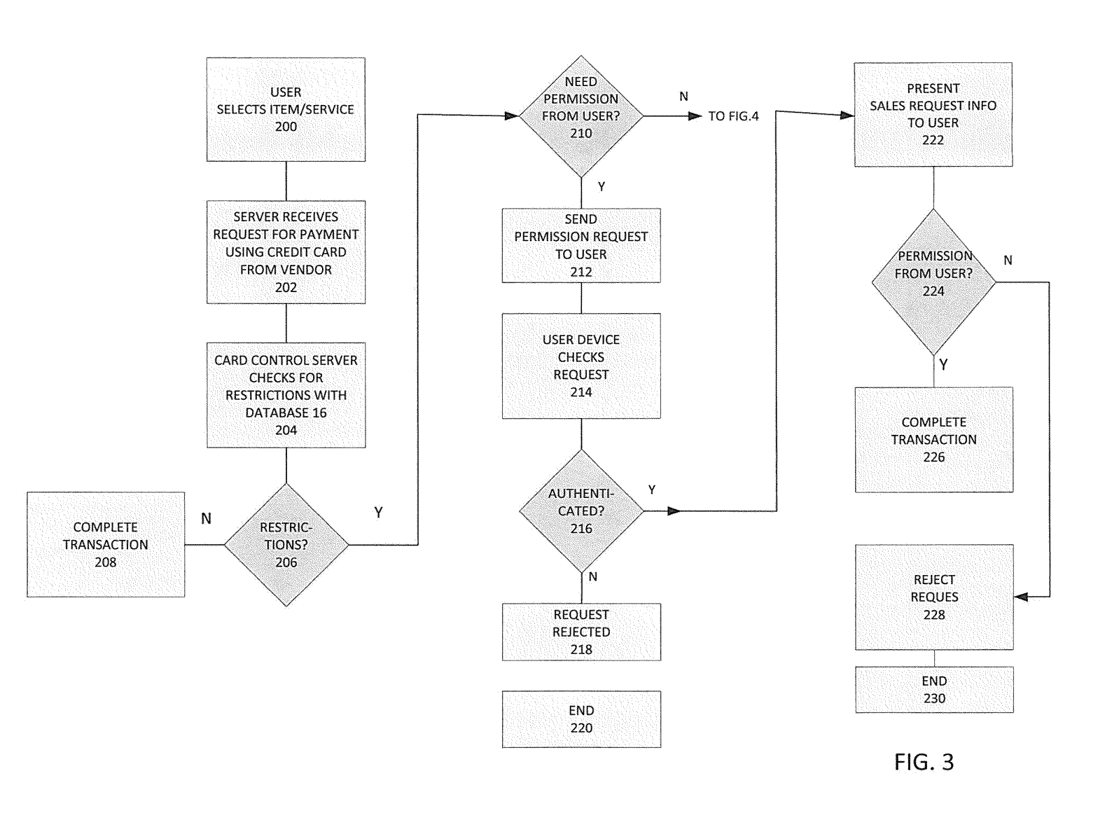

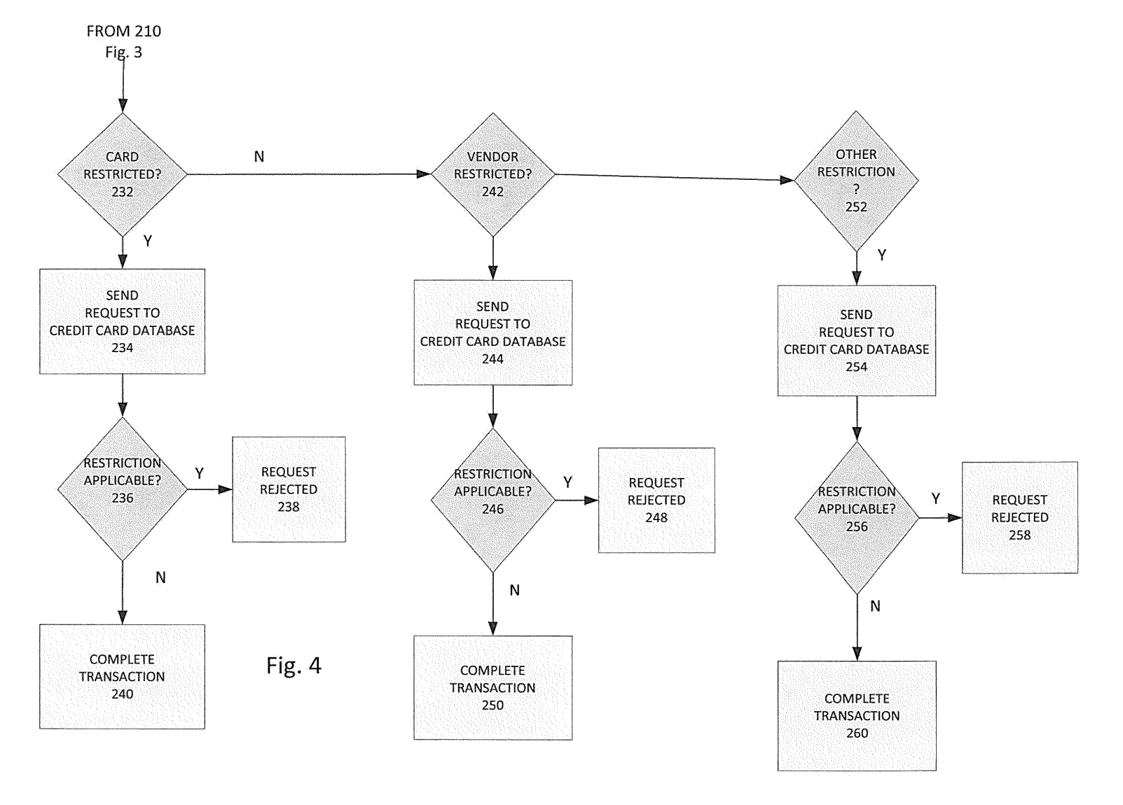

FIGS. 3 and 4 show a flow chart illustrating how a transaction may be conducted on the system of FIG. 1. In step 200 the user selects an item or service that he would like to purchase (as previously discussed, this step may include obtaining cash from an ATM) from one of the vendors 20 or the ATM 22.

In step 202 the card control server 14 receives a request for payment for the selected item or service. The request includes identification information identifying one of the cards associated with the user 10. If no restrictions are found for the particular transaction (step 206) then payment is authorized by the control server 14 and the transaction is complete (step 208).

If in step 206 a restriction is indicated, then in step 210 a check is performed to determine whether permission is needed from the user for the payment. If yes, then in step 212 a permission request is send by the server 14 to the device 12. In step 214 the user device determines whether the request is accurate. For example, the request may include an identification of the payment card to be used. The device 12 may include a listing of all the cards associated with user 10 and may authenticate the request locally (step 216) or may confirm with the database 16 whether the payment card identified in the request is properly associated with the user 10 or not. If the payment card (or any other part of the request) cannot be authenticated in step 216 then in step 218 the request is rejected and the transaction is terminated in step 220.

If in step 216 the request is found to be authentic then in step 222 a sales request is presented to the user 10 indicating, for example, the vendor, the item or service, the cost(s), etc. In step 224 the user provides an appropriate input to the device 12 either accepting or rejecting the request. If the request is rejected then in step 228 an appropriate message is sent to the server 14, the server 14 informs the vendor and the transaction ends (step 230). If the user indicates that he is accepting the request then the device 12 sends an appropriate message to the server 14 and the transaction is completed (step 226).

Going back to step 210, if no user permission is required, then in step 232(FIG. 4) a check is performed to determine if the card specified in the request has any restrictions, by checking with the database 16. If there are card-specific restrictions then in step 234 a corresponding request is sent by server 14 to the database 16 to determine what the restrictions are and whether the restrictions are applicable to the current transaction. If the restrictions apply then the request is rejected in step 238. If the restrictions do not apply then the transaction is completed (step 240).

While the flow charts show one way to implement the invention, there are many other ways of implementation as well. For example, in one embodiment, the user selects to restrict at least one card completely so that it it can only be used after authorization is received from the user. In another embodiment, after a card is used for payment, the user sends a command to the server 14 restrict the card again.

In one embodiment, the user can contact the card control server 14 and reset or establish the rules at any time as described in detail in conjunction with FIG. 2.

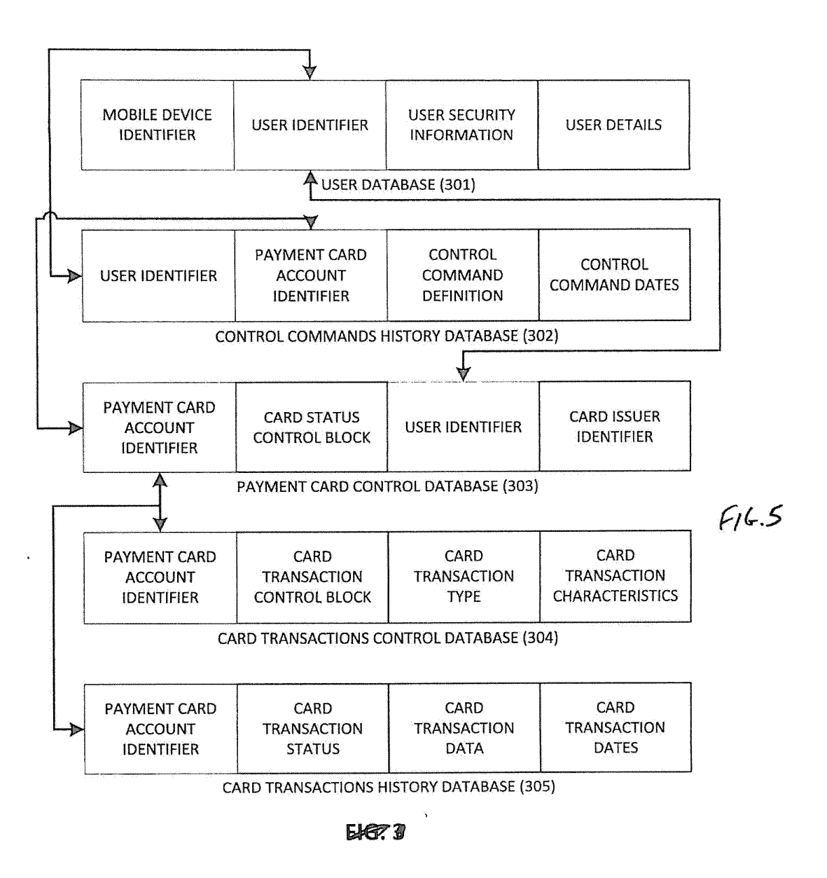

As discussed above, the database 16 is used to store information identifying each user, payments cards of the users, devices associated with each user, etc. As illustrated in FIG. 5, the database 16 may include several files, such as a user file 301, a control command file 302, a payment card control file 303, card transaction control file 304 and a card transaction history file 305.

The user file 301 includes a mobile device identifier, a user identifier, user security information, and user details.

The mobile device identifier uniquely identifies the mobile device (usually a mobile phone) of the user. Several different mobile devices may be used by the same user to send control commands to the system as described.

The User Identifier uniquely identifies each user. User Identifier is what allows the system to associate all payment cards with a particular user. Some payment cards may be associated with several users. For example, a parent and a child or a husband and wife may share a payment card.

User Security Information includes a password or other credentials preferably in an encrypted form

The details of each user, includes additional information such as billing information, address, etc.

The control command history file 302 may include the user identifier, a payment card account identifier, control command definitions describing control commands generated by the server 14 and the dates on which these commands have been issued.

The payment card control file 303 may include the payment card account identifier, a card control status information or block, the user identifier and a card issuer identifier.

The card transaction control file 304 includes the payment card account identifier, a card transaction information block, a card transaction type, and some card transaction characteristics.

The card transactions history file 305 may include the payment card account identifier, the card transactions status, a card transaction data block and card transaction dates.

As can be seen in the Figure, some information information or data is shared between the various files.

These files are used to keep track of various events associated with each user, each payment card and each transaction for billing purposes and various other tracking functions.

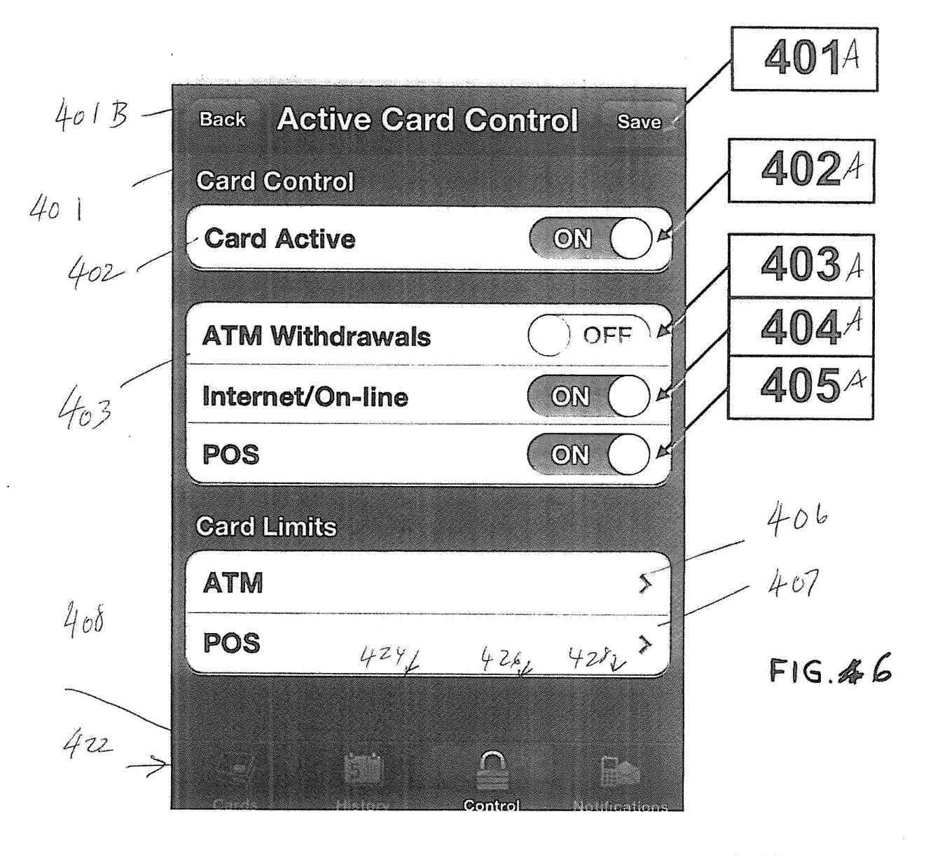

Various means may be provided for enabling the user to control his payment card(s). One preferred means is via his smart phone. FIG. 6 represents a Graphical User Interfaces (GUI) for sending control commands via the smart phone in accordance with an embodiment of the invention and is implemented by an application on the device 12. The GUI is formed with several zones 401, 402, 403, 406, 407 and 408.

Zone 408 provides a basic control area provided with several buttons 422, 424, 426, 428, that are labeled CARDS, HISTORY, CONTROL and NOTIFICATION. This zone 408 is common for many of the functions performed by the device 12 for this invention When button 422 is selected, the user gets a listing of all the cards registered with the system (not shown). He can select any one of them to see and change the control parameters associated with that card by selecting the control button 426 and causing the screen shown in FIG. 6 to appear on the device 12. Other screens maybe provided for other functionalities as described below.

Zone 401 shows the current card for which the controls are being reviewed/selected and it includes a SAVE and a BACK button that are self-explanatory.

In zone 402, the user can determine whether the selected card is active or not with a button 402A. If the card is set to be inactive, it cannot be used to make any transactions. As discussed above, in one mode of operation, the user normally leaves the button 402A OFF. Then, every time he makes a transaction, he activates the application on the device 12 and causes the GUI of FIG. 6 to be presented. He then temporarily sets this button 402A to the ON position. The device 12 then sends an appropriate control signal as discussed above. Once the transaction is complete, the user sets the button 402A back to the OFF position.

In another embodiment, the button 402A is automatically reset to the OFF position after the transaction is complete, after a predetermined time has expired, etc.

In another embodiment the button 402A is left on the ON position. For this embodiment, the user can make further choices as to different types of transactions that may be automatically allowed. For example, the user may independently activate any of the buttons 403A, 403B and/or 403C and thereby determine whether the card can be used for ATM withdrawals, Internet/on-line shopping, and/or POS (Point of Sales) transactions,

Zones 406 and 407 may be selected to set limits on certain kinds of transactions, such as the limit on how much money can be withdrawn from an ATM (zone 408), how much money can be spent at a POS transaction (zone 407), etc..

Of course, the GUI of FIG. 5 is merely exemplary and many other configurations and selection parameters may be provided to the user.

In one embodiment, of the invention, the application used to control payment card may also be used as a floating prepaid debit card. In this embodiment, the user can designate a predetermined amount (e,g., $100.00) to be transferred to a cash account associated with the device 12 from a standard debit or credit card to his credit account. Then, any transaction associated with the user can be paid for from this credit account.

Numerous modifications may be made to this invention without departing from its scope as defined in the appended claims.

1. A system for performing a transaction in which a user obtains goods and services from a vendor using a payment card issued by a payment institutioncomprising:
a user device associated with the user and generating a selective command in response to an input from the user, said command defining a restriction on the transaction; and
a control server separated from and operating independently of said vendor and said payment institution, said control server receiving a payment request from one of the vendor and thment institution for payment from a payment, said control server approving the transaction for payment only if permitted by said control command.

2. The system of claim 1 wherein said user device is a hand-held device.

3. The system of claim 1 wherein said user device is set to generate a restrictive command and wherein said control server is adapted to authorize payment only when a predetermined rule associated with said restrictive command is met.

4. The system of claim 3 wherein said rule is a card-specific rule dependent on what payment card is being used for the payment.

5. The system of claim 3 wherein said rule is a vendor specific rule dependent on the vendor.

6. The system of claim I wherein said user device is adapted to generate a restrictive command that restricts any payment from the payment card until an express authorization for a specific transaction is received from the user.

7. A method of providing a payment associated with a payment card for a transaction for goods or services from a vendor using a system including a card control server separate and independent of the vendor or the institution issuing the payment card and a user device adapted to receive an input from the user and to generate a command responsive to said input, comprising the steps of:
receiving a request by the card control server for a payment from the vendor associated with the payment card of the user;
determining by the card control server whether the payment associated with the payment card is authorized by the user; and
authorizing by the server the payment when the payment is authorized by the user as indicated by the user device.

8. The method of claim 7 wherein the payment card is initially blocked by the user device for any transactions, further comprising sending the request by said card control server to said user device, receiving by the user device an input from the user indicating authorization for said payment and receiving authorization by the card control server from the user device for payment.

9. The method of claim 7 wherein the card control server makes the determination based on a rule.

10. The method of claim 9 wherein the rule is dependent on the payment card.

11. The method of claim 10 wherein said user has several payment cards, said request includes an identification of a selected payment card and wherein said server makes said determination by determining if said rule is applicable to the selected payment card.

12. The method of claim 9 wherein said rule is dependent on the vendor,

13. The method of claim 7 wherein the system includes a database server serving several users and said card control server generates data specific to each user and transaction and sends said data to said database server for storage.

14. The method of claim 9 wherein said rule is geographic location dependent.

15. The method of claim 9 further comprising determining by the server a special transaction, and authorizing a special requests associated with a special transaction without receiving any commands from the user device.

16. The method of claim 15 wherein special transactions are recognized based on the past history of transactions for a specific user.
